(19) United States
(12) Patent Application Publication
(10) Pub. No.: US 2013/0105092 A1
(43) Pub. Date: May 2, 2013

(54) Door Cover Device

(71) Applicants: Peter M. Rainaldi, Ramsey, NJ (US); David Valentin, Mahwah, NJ (US); Robert Scott Bakay, New Milford, CT (US)

(72) Inventors: Peter M. Rainaldi, Ramsey, NJ (US); David Valentin, Mahwah, NJ (US); Robert Scott Bakay, New Milford, CT (US)

(21) Appl. No.: 13/285,042

(22) Filed: Oct. 31, 2011

(51) Int. Cl. E06B 5/00

(52) U.S. Cl. 160/103; 160/90

(57) ABSTRACT

The present invention is a door cover useful for covering a door that one would like to hide for various reasons not limited to dings, nicks, scratches, color fading, paint chipping, or simple dislike of design or color. In addition to the utility of hiding an aspect of a door, the door cover also offers an easy, cheap, and quick method of securely fastening a new style to a door. This new style can consist of endless artistic opportunities, not limited to numerous different colors, materials, patterns and textures. The fitted door cover can accommodate any style imaginable, to include any artist style, holiday representations, represent political affiliations, sporting loyalties, characters, brands, logos, as well as many other possible expressions of individuals, such as monograms.

### BACKGROUND OF INVENTION

This invention relates generally to devices that cover doors. More specifically, this invention relates to a door cover that conceals imperfections or negative aspects of a door, while allowing for a display of style, brand, character, logo, and/or design at the same time.

### Description of Prior Art

Various cover types are well known in the art. For example, U.S. Pat. No. 4,475,768, to Webb, which discloses a fitted seat cover, which is secured to the underside of a seat using Velcro. The utility of the invention is to allow the user to adapt the chair to its environment, or be able to change decor at any moment.

U.S. Pat. No. 5,922,437 Bryant, relates to fitted covers for household items using a pliable material comprising a bag-like structure with an opening. Patent U.S. Pat. No. 5,713,615, to Tsai, describes a Stretchable door knob cover useful for improving the appearance and operation of a doorknob by means of a cover. U.S. Pat. No. 6,714,167 issued to Gusick describes a satellite dish cover using a decorated fabric.

However, there is a need for a device used to cover a door that is easier to apply and remove while still being easy and inexpensive to manufacture. One of the objects of this device is to satisfy this need.

### SUMMARY OF INVENTION

The present invention is directed to a fitted cover for doors and other similarly shaped items. The fitted cover secures to a door by means of 4 elastic corners snuggly covering the corners of a door and has a piece of material in at least one corner attached thereto and protruding outward therefrom for aiding the securing and then removal of the cover from the door. The snug fit of this invention allows the cover to remain in place, despite frequent opening, closing and possible slamming of a door. This fitted door cover serves the purpose of hiding warps, scratches, dings, cracked, broken, old, and generally unpleasant looking doors, and/or to be able to change decor at any moment. At the same time the present invention is useful for hiding unpleasantries of a door, it also has the potential to offer a fresh attractive look. The fitted door cover can vary in aesthetic design, to include different colors, materials, patterns and textures. The fitted door cover can accommodate any style imaginable, to include any artist's style, holiday representations, represent political affiliations, sporting loyalties, brands, logos, characters, slogans, word phrases, images, reproduction of photograph images, as well as many other possible expressions of individuals, such as monograms. The device can display one or more designs or images consisting of letters, words, and/or images The fitted cover allows for one to adapt the door to its environment, and to change the style quickly, easily and cheaply. The fitted cover is easy to maintain and transform. Other similarly shaped items which the fitted cover could accommodate include cupboards, windows and drawers. Still further uses and advantages will become apparent from a consideration of the ensuing description and drawings. The device is reusable.

### BRIEF DESCRIPTION OF DRAWINGS

FIG. 1. Shows a frontal view of the door (7) wearing the door cover (1) with the outer view of the door cover (1) showing, which may contain visual information. Also shows doorpost or frame (9).

FIG. 2. Shows a frontal view of the door (7) wearing the door cover (1) with an optional doorknob cutout with elastic around the edge of the cutout (15).

FIG. 3. Shows the side view of the door (7) wearing the door cover (1), exposing the connection between the inner elastic material of the door cover (11) and the 4 corners of the door (7), both frontal and back views, and has a piece of material (13) in one corner attached thereto and protruding outward therefrom for aiding the securing and then removal of the cover (1) from the door (7).

FIG. 4. Shows a rear view of the door (7) wearing the door cover (1) including the elastic component (11) which secures the cover to the door, and has the piece of material (13) in one corner protruding outward therefrom.

FIG. 5. Shows a frontal view of the door (7) wearing the door cover (1) with the outer view of the door cover (1) showing and also shows a piece of material (13) in four corners attached thereto and protruding outward therefrom for aiding the securing and then removal of the cover (1) from the door (7).

FIG. 6. Shows a rear view of the door (7) wearing the door cover (1), exposing the connection between the inner elastic material of the door cover (11) and the 4 corners of the door, and has a piece of material (13) in four corners attached thereto and protruding outward therefrom for aiding the securing and then removal of the cover (1) from the door (7).

### DETAILED DESCRIPTION OF THE DRAWINGS AND INVENTION

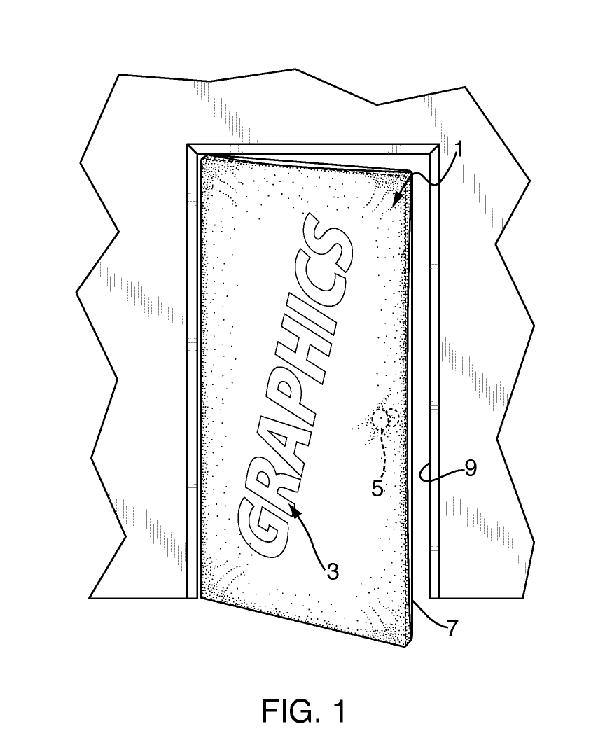

FIG. 1 shows a standard door (7) with a frontal view wherein the inner view of the cover (1) will connect and be secured to. The perimeter of the cover is made to coincide with the rim of the door. A standard door which can be an entry door that is typically 80″ high×36″ wide. Interior doors are typically 80″×30″, 28″, 32″ or 34″, or in that range, also shown is the possibility that visual information (3) can be on the outer view of the door cover. This can include but is not limited to aesthetic designs which include a multitude of different colors, materials, patterns and textures. The fitted door cover (1) can accommodate any style imaginable, to include any artist style, holiday representations, represent political affiliations, sporting loyalties as well as many other possible expressions of individuals, such as monograms. The fitted cover allows for one to adapt the door to its environment, and to change the style quickly, easily and cheaply. The fitted cover (1) is easy to maintain and transform. The fitted door cover (1) is intended to cover, mask, or conceal negative aspects of the door, and/or be able to change the decor of the door at any moment. For example, a door might be damaged by a large scratch and too expensive to replace. Also a door might be a wrong color, cracked, faded, have paint chipping. It might have a ding or a dent, it might even have a hole. Any of these features can easily be hidden with a door cover (1).

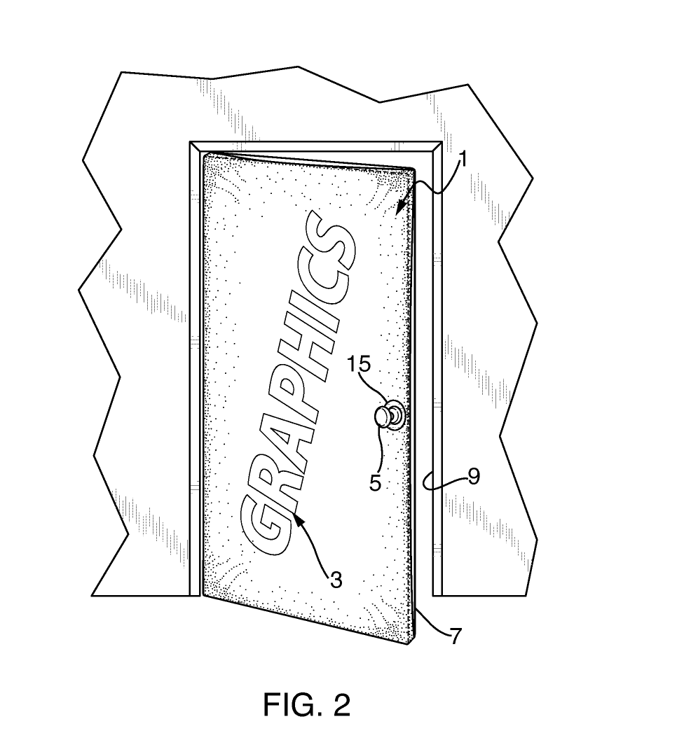

FIG. 2 shows the frontal view of a standard door (7) wherein the inner view of the cover (1) will connect to and be secured to. It also shows the doorknob (5) and how the cover can have a perimeter cut out with elastic material (15) to surround and perfectly fit a doorknob (5).

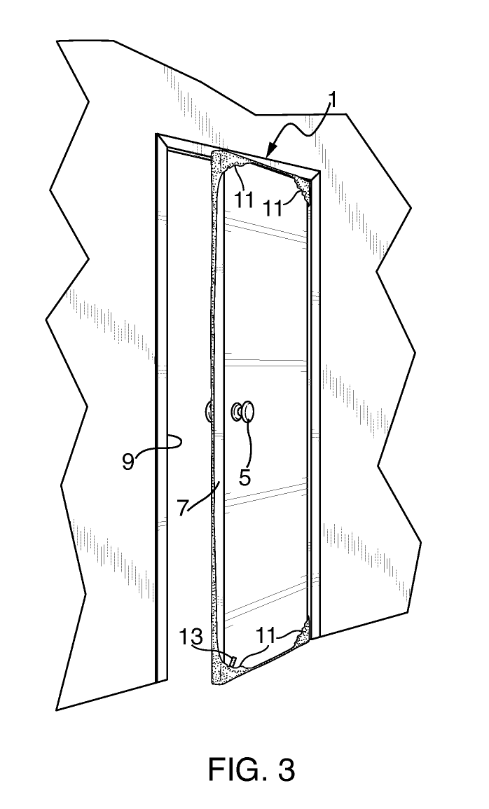

FIG. 3. Shows the side view of the door (7) wearing the door cover (1), exposing the connection between the inner elastic material of the door cover (11) and the 4 corners of the door (7), both frontal and back views and has a piece of material in one corner (13) attached thereto and protruding outward therefrom for aiding the securing and then removal of the cover (1) from the door (7). FIG. 3 shows how the elastic material (11) makes contact with and is attached tightly and securely to the frontal and back 4 corners of the door (7).

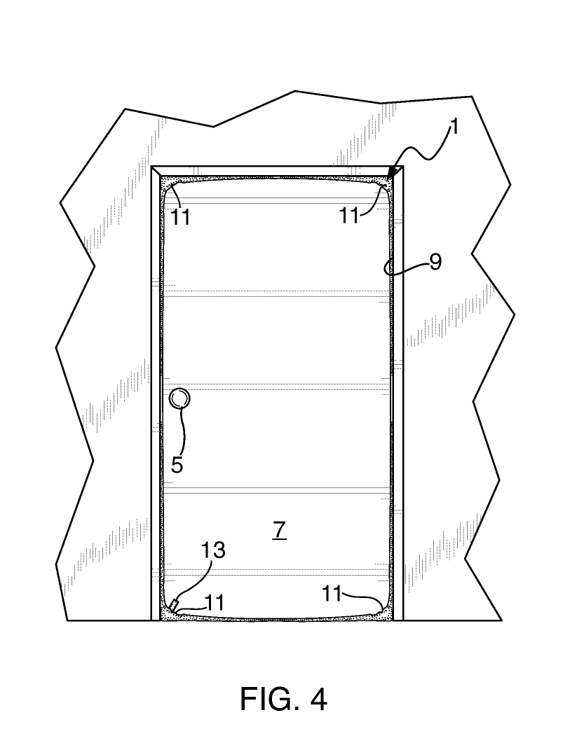

FIG. 4. Shows a rear view of the door cover (1) including the elastic component (11) which secures the cover to the door, and has the piece of material (13) in one corner protruding outward therefrom.

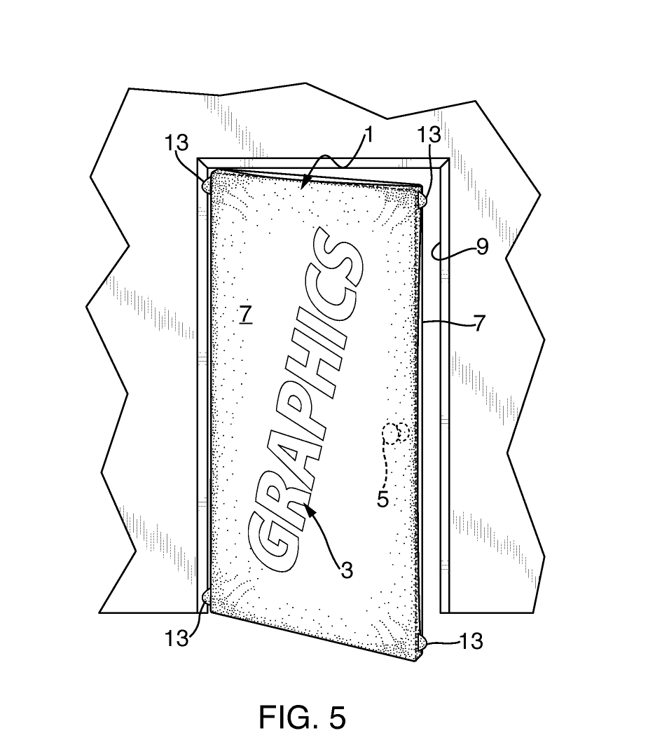

FIG. 5. Shows a frontal view of the door (7) wearing the door cover (1) with the outer view of the door cover showing and also shows a piece of material (13) in four corners attached thereto and protruding outward therefrom for aiding the securing and then removal of the cover (1) from the door (7).

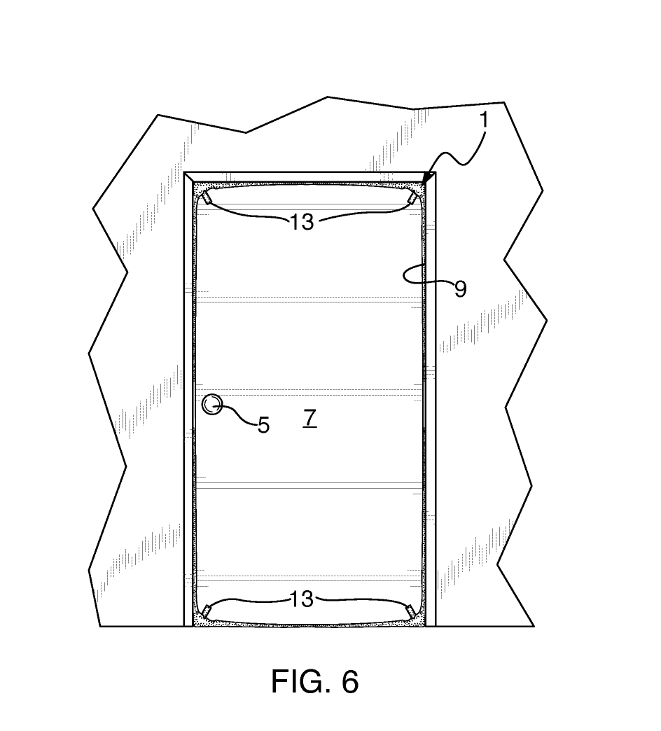

FIG. 6. Shows a rear view of the door (7) wearing the door cover (1), exposing the connection between the inner elastic material of the door cover (11) and the 4 corners of the door (7), and has a piece of material in four corners (13) attached thereto and protruding outward therefrom for aiding the securing and then removal of the cover (1) from the door (7).

1. A device that covers a portion of a rectangular shaped door while still maintaining the doors operating function, comprising: a piece of stretchable and printable material with corners for secure fastening to the door and a strap of material in at least one corner attached thereto and protruding outward there from for aiding the securing and then removal of the cover from the door.

2. The device of claim 1, wherein the securing means are elastic bands attached to or imbedded in each of the four corners of the perimeter of said material to conformably secure said material over said door in all four corners.

3. The device in claim 1, wherein the material further comprises a hole that would allow a doorknob to remain uncovered by the material intended to cover the door.

4. The device in claim 1, wherein the material further comprises a hole that would allow a doorknob to remain uncovered by the material intended to cover the door, whereby the hole has an outer portion that is elastic to allow easy attaching and removal of the cover allowing for the doorknob to protrude outward from the door with secured cover attached thereto.

5. The device in claim 1, wherein the material piece protruding out from a corner of the cover is elastic.

6. The device in claim 1, wherein the strap of material protruding out from a corner of the cover is cloth.

7. The device in claim 1, wherein the strap of material protruding out from a corner of the cover is looped in the middle and attached at both ends to the corner of the cover.

8. The device in claim 1, wherein there are two, three, or four straps of material for aiding the securing and removal of the device, each of which are protruding out from a corner of the cover.

9. The device in claim 1, wherein the displayed design or image consisting of letters, words, or images can be printed on both sides of the device.

10. The device in claim 1, wherein the device is reusable.

11. The device in claim 1, wherein the device is reversible and either side can face the door, the other side facing outward from the door.
